(19) United States
(12) Patent Application Publication
(10) Pub. No.: US 2025/0292497 A1
(43) Pub. Date: Sep. 18, 2025

(54) MACHINE LEARNING MODELS FOR RECONSTRUCTION AND SYNTHESIS OF DYNAMIC SCENES FROM VIDEO

(71) Applicant: NVIDIA Corporation, Santa Clara, CA (US)

(72) Inventors: David Jesus ACUNA MARRERO, Toronto (CA); Or LITANY, Sunnyvale, CA (US); Amlan KAR, Toronto (CA); Zan GOJCIC, Zurich (CH); Sanja FIDLER, Toronto (CA)

(73) Assignee: NVIDIA Corporation, Santa Clara, CA (US)

(21) Appl. No.: 18/602,834

(22) Filed: Mar. 12, 2024

(51) Int. Cl. G06T 17/00; G06T 7/70; G06V 10/44

(52) U.S. Cl. CPC G06T 17/00; G06T 7/70; G06V 10/44; G06T 2207/20084

(57) ABSTRACT

In various examples, systems and methods are disclosed relating to reconstruction and synthesis of dynamic scenes from video, such as to generate a four-dimensional (4D) representation of one or more scenes based on one or more videos (e.g., two-dimensional (2D) videos) of the one or more scenes. A system may determine, using a neural network and based on a three-dimensional (3D) representation of one or more scenes, a 4D representation of the one or more scenes, the 3D representation generated by a featurizer using a plurality of first image frames from video data of the one or more scenes. The system may determine, from the 4D representation, a target image having a target pose and a target time.

### BACKGROUND

Machine learning models, such as neural networks, can be used to process image data from cameras and other sensors in order to detect objects or other features in environments. This can be performed, for example, to reconstruct and/or synthesize one or more image frames. However, such approaches may lack realism or quality, including when used for reconstruction and/or synthesis of dynamic scenes from video data.

### SUMMARY

Embodiments of the present disclosure relate to systems and methods for reconstruction and synthesis of dynamic scenes from video, such as to generate a four-dimensional (4D) representation of one or more scenes based on one or more videos (e.g., two-dimensional (2D) videos) of the one or more scenes. For example, the systems can receive a subset of image frames, such as a subset of image frames from one or more videos to be used as training data, and determine feature data from the subset of the image frames. The systems can include one or more machine learning models that can generate the 4D representation or 4D content model for reconstruction and synthesis of dynamic scenes from video using the determined feature data in 3 dimensions (3D). As compared with conventional systems, e.g., optimization-based approaches, systems and methods in accordance with the present disclosure can more accurately generate representations of scenes for synthesizing novel views of the scenes with less sufficient data available regarding the scenes, such as to generate 4D content (e.g., 3D video data) from video data (e.g., 2D video data from a monocular camera).

At least one aspect relates to a processor. The processor may include one or more circuits to determine, using a neural network and based on a three-dimensional (3D) representation of one or more scenes, a four-dimensional (4D) representation of the one or more scenes, the 3D representation generated by a featurizer using a plurality of first image frames from video data of the one or more scenes. The one or more circuits may determine, from the 4D representation, a target image having a target pose and a target time.

In some implementations, the featurizer may include at least one of a latent diffusion model, a flow model, or a depth model. In some implementations, the featurizer may be a pre-trained model configured (e.g., trained, updated, etc.) using vehicle camera data.

In some implementations, the 3D representation may include a 3D feature cloud, and the 4D representation may include at least one of a 4D tensor or a 4D neural radiance field (NeRF). In some implementations, the one or more circuits may apply a volume rendering to the 4D representation, according to the target pose and the target time, to retrieve the target image.

In some implementations, the neural network may include a transformer. The one or more circuits may update the transformer by identifying a second image frame of the video data of the one or more scenes, the second image frame having a second pose and a second time. The one or more circuits may determine, from the 4D representation, an estimated image having the second pose and the second time. The one or more circuits may update the transformer according to a comparison of the estimated image with the second image frame. The one or more circuits may perform the comparison of the estimated image and the second image frame according to a photometric loss function. The plurality of first image frames may have a plurality of first time steps, and the second image frame may have a second time step subsequent to the plurality of first time steps.

At least one aspect relates to a system including one or more processors to execute operations. The operations may include receiving an input indicating one or more features of content, the content representing at least one of an object or a scene. The operations may include initializing a content model that is generated by a neural network using a transformation, according to the input, to represent one or more images in three spatial dimensions and a fourth dimension. The operations may include updating the content model by rendering one or more image frames from the content model, determining a metric of the one or more frames, and modifying the content model according to the metric, until a convergence condition is satisfied.

In some implementations, the input may be generated using a plurality of first image frames from video data of one or more scenes. In updating the content model, the one or more processors may identify a second image frame of the video data of the one or more scenes, the second image frame having a pose and a time. The one or more processors may determine, from the content model, an estimated image having the pose and the time. The one or more processors may update the neural network according to a comparison of the estimated image with the second image based on the metric. The plurality of first image frames may have a plurality of first time steps. The second image frame may have a second time step subsequent to the plurality of first time steps.

At least one aspect relates to a processor. The processor may include one or more circuits to determine, using a neural network and based on a three-dimensional (3D) representation of one or more scenes, a four-dimensional (4D) representation of the one or more scenes, the 3D representation generated by a featurizer using a plurality of first image frames from video data of the one or more scenes. The one or more circuits may identify a second image frame of the video data of the one or more scenes, the second image frame having a second pose and a second time. The one or more circuits may determine, from the 4D representation of the one or more scenes, an estimated image having the second pose and the second time. The one or more circuits may update the neural network according to a comparison of the estimated image with the second image frame.

In some implementations, the one or more circuits may perform the comparison of the estimated image and the second image frame according to a photometric loss function. In some implementations, the plurality of first image frames may have a plurality of first time steps, and the second image frame may have a second time step subsequent to the plurality of first time steps.

At least one aspect relates to a method. The method may include generating, using one or more processors by a featurizer using a plurality of first image frames from video data of one or more scenes, a three-dimensional (3D) representation of the one or more scenes. The method may include determining, by the one or more processors using a neural network and based on the 3D representation of the one or more scenes, a four-dimensional (4D) representation of the one or more scenes. The method may include determining, using the one or more processors from the 4D representation, a target image having a target pose and a target time.

In some implementations, the featurizer may include at least one of a latent diffusion model, a flow model, or a depth model. In some implementations, the 3D representation may include a 3D feature cloud, and the 4D representation may include at least one of a 4D tensor or a 4D neural radiance field (NeRF). In some implementations, the method may include applying a volume rendering to the 4D representation, according to the target pose and the target time, to retrieve the target image.

In some implementations, the method may include identifying a second image frame of the video data of the one or more scenes, the second image frame having a second pose and a second time. The method may include determining, from the 4D representation, an estimated image having the second pose and the second time. The method may include updating the neural network according to a comparison of the estimated image with the second image frame.

In some implementations, the method may include performing the comparison of the estimated image and the second image frame according to a photometric loss function. In some implementations, the plurality of first image frames may have a plurality of first time steps, and the second image frame may have a second time step subsequent to the plurality of first time steps.

The processors, systems, and/or methods described herein can be implemented by or included in at least one of a system for generating synthetic data; a system for performing simulation operations; a system for performing conversational AI operations; a system for performing collaborative content creation for 3D assets; a system including one or more large language models (LLMs); a system for performing digital twin operations; a system for performing light transport simulation; a system for performing deep learning operations; a system implemented using an edge device; a system implemented using a robot; a control system for an autonomous or semi-autonomous machine; a perception system for an autonomous or semi-autonomous machine; a system incorporating one or more virtual machines (VMs); a system implemented at least partially in a data center; or a system implemented at least partially using cloud computing resources.

### BRIEF DESCRIPTION OF THE DRAWINGS

The present systems and methods for reconstruction and synthesis of dynamic scenes from video data using neural networks are described in detail below with reference to the attached drawing figures, wherein:

FIG. 1 is a block diagram of an example system for reconstruction and synthesis of dynamic scenes from video data using neural networks, in accordance with some embodiments of the present disclosure;

FIG. 2A is a schematic diagram of an example system environment for reconstruction and synthesis of dynamic scenes from video data, in accordance with some embodiments of the present disclosure;

FIG. 2B is a schematic diagram of an example neural network that can be used in the example system of FIG. 1, in accordance with some embodiments of the present disclosure;

FIG. 2C is a schematic diagram of an example 3D content model that can be generated by the example system of FIG. 1 for reconstruction and synthesis of dynamic scenes, in accordance with some embodiments of the present disclosure;

FIG. 2D is a schematic diagram of an example 4D content model that can be generated by the example system of FIG. 1 for reconstruction and synthesis of dynamic scenes, in accordance with some embodiments of the present disclosure;

FIG. 2E is a schematic diagram of example image frames that can be used by the example system of FIG. 1 for reconstruction and synthesis of dynamic scenes, in accordance with some embodiments of the present disclosure;

FIG. 3 is a flow diagram of an example of a method for reconstruction and synthesis of dynamic scenes from video data using neural networks, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods in accordance with the present disclosure relate to reconstruction and synthesis of dynamic scenes from video, such as to generate a four-dimensional (4D) representation (e.g., a 4D content model) of one or more scenes based on one or more videos (e.g., two-dimensional (2D) videos) of the one or more scenes. The 4D representation (e.g., a 4D content model) can be used to perform operations such as rendering novel views from the 4D representation, 3D object detection and open-vocabulary 3D segmentation (e.g., 3D segmentation using classes beyond the classes labeled during the training phase). Systems and methods in accordance with the present disclosure can more accurately generate representations of scenes for reconstructing/synthesizing novel views of the scenes with less sufficient data available regarding the scenes, such as to generate 4D content (e.g., three-dimensional (3D) video data) from video data (e.g., 2D video data from a monocular camera).

In some systems, synthesizing novel views of scenes captured by cameras can be useful for various technologies, including but not limited to simulation technologies. However, it can be challenging to have sufficient data available regarding a scene to accurately generate novel views, such as views not explicitly represented by the data. For example, the data available for a scene may have video that includes image frames from a camera (e.g., a moving camera), and the image frames may represent objects that move and/or deform with respect to a field of view of the camera. In some instances, such data includes a video stream from a monocular camera, including but not limited to a monocular camera of an autonomous vehicle. Various such considerations can limit the availability of data that represents the objects with a high level of detail from multiple sides, or other otherwise allows for relationships to be determined between the same objects across image frames. While optimization-based approaches (e.g., optimization of camera poses and/or 3D scene structure) can be useful for novel view synthesis, they may be limited in effectiveness given such considerations; for example, such approaches may overfit individual scenes and may be ill-equipped to handle monocular reconstruction of dynamic scenes.

Systems and methods in accordance with the present disclosure can more accurately generate representations of scenes for synthesizing novel views of the scenes, such as to generate 4D content (e.g., 3D video data) from video data (e.g., 2D video data from a monocular camera). The system can include one or more machine learning models that are configured (e.g., trained, updated) using training data that includes one or more videos that can be represented as a sequence of images, each image having a time (e.g., time step, time point) and a camera pose indicating a pose (e.g., position and orientation relative to a given coordination system) of the camera that captured the video. In some implementations, each image may be associated with data values including a point X in a scene/object captured in the image (e.g., a point in the scene/object positioned in a center of the image), a direction (or direction vector) Z from the point X to a camera, a distance or depth d from the point X to the camera, and/or a time t. The machine learning models can include various neural network-based models.

The machine learning models can include at least one featurizer model which can be pretrained (e.g., using existing general purpose datasets or specific scenes related to the task, such as scenes from autonomous vehicle camera captures) or learned (e.g., as part of training the overall machine learning model architecture). For example, the at least one featurizer may include at least one of a pre-trained featurizer; an encoder, a latent diffusion model (LDM), a vector quantized variational auto-encoder (VQVAE), a flow model, a recurrent all-pairs field transforms (RAFT) flow model, or a (pre-trained) depth model, etc.

The featurizer model can receive a subset of image frames, such as a subset of image frames from one or more videos to be used as training data, and determine feature data from the subset of the image frames. A remaining one or more image frames of the training data can be used for supervision as described further herein. For example, the remaining image can be from a time step t₃, having a target pose (e.g., a combination of position and orientation of a camera), while the images of the subset can be from time steps t₀, t₁, t₂. As such, the featurizer model can determine features from the images at time steps t₀, t₁, t₂. The featurizer can determine features relating to various groups of pixels.

The determined features (e.g., features Φ) can be used to generate a three-dimensional (3D) feature representation or a 3D feature cloud (e.g., voxel-based representations of 3D objects), which can be provided to a transformer model or a transformer (e.g., the transformer model can receive the 3D feature cloud as input). The transformer can determine (e.g., predict) parameters of a 4D content model (e.g., 4D rendering model [symbol] _{C}) corresponding to the scenes from the one or more videos. In some implementations, the transformer can also determine (e.g., predict) parameters of a 3D content model (e.g., 3D rendering model [symbol] _{σ}) corresponding to the static part of the scenes from the one or more videos.

To update (e.g., train) the transformer model, an estimated image (e.g., estimate an image Î_{σ}, or Î_{C}) corresponding to an example image (e.g., the remaining image from the time step t₃) can be retrieved (or calculated, computed, obtained) from the transformer model (or from the 4D rendering model [symbol] _{C}), for example, by performing volume rendering on the 4D content model with respect to a set of data values corresponding to the example image (e.g., a point X in a scene/object captured in the example image, a feature vector Z that has a representation of the point X, a distance or depth d from the point X to the camera, and/or the time t=t₃). A comparison of the estimated image and the example image, such as with a loss function (e.g., photometric and regularization loss functions), can be used to update the transformer model until such comparisons satisfy a convergence condition. This update process can provide for a 4D representation (or a 4D content model) of the one or more scenes that can be used for high quality generation of novel views as well image processing tasks such as object detection, perception, and segmentation. In comparing the estimated image and the example image, the systems can warp (e.g., non-linear transform) the feature space (e.g., 3D feature representation or 3D feature cloud of the determined features ¢) using a transformation (e.g., a warped k-nearest neighbor algorithm), to stretch or compress different dimensions differently, thereby more accurately capturing the true data geometry.

The systems and methods described herein may be used for a variety of purposes, by way of example and without limitation, for autonomous or semi-autonomous machine applications, map generation, machine control, machine locomotion, machine driving, model training, perception, simulation, environment simulation, object or actor simulation and/or digital twinning, light transport simulation (e.g., ray-tracing, path tracing, etc.), collaborative content creation for 3D assets, deep learning, augmented reality, virtual reality, mixed reality, robotics, security and surveillance, data center processing, conversational AI, synthetic data generation, data center processing, cloud computing and/or any other suitable applications.

Disclosed embodiments may include a variety of different systems such as systems for performing synthetic data generation operations, automotive systems (e.g., a control system for an autonomous or semi-autonomous machine, a perception system for an autonomous or semi-autonomous machine), systems for performing simulation operations, systems for performing digital twin operations, systems for performing light transport simulation, systems for performing collaborative content creation for 3D assets, systems for performing deep learning operations, systems implemented using an edge device, systems implemented using a robot, aerial systems, medical systems, boating systems, smart area monitoring systems, systems for performing conversational AI operations, systems for generating synthetic data, systems incorporating one or more virtual machines (VMs), systems implemented at least partially in a data center, systems implemented at least partially using cloud computing resources, and/or other types of systems.

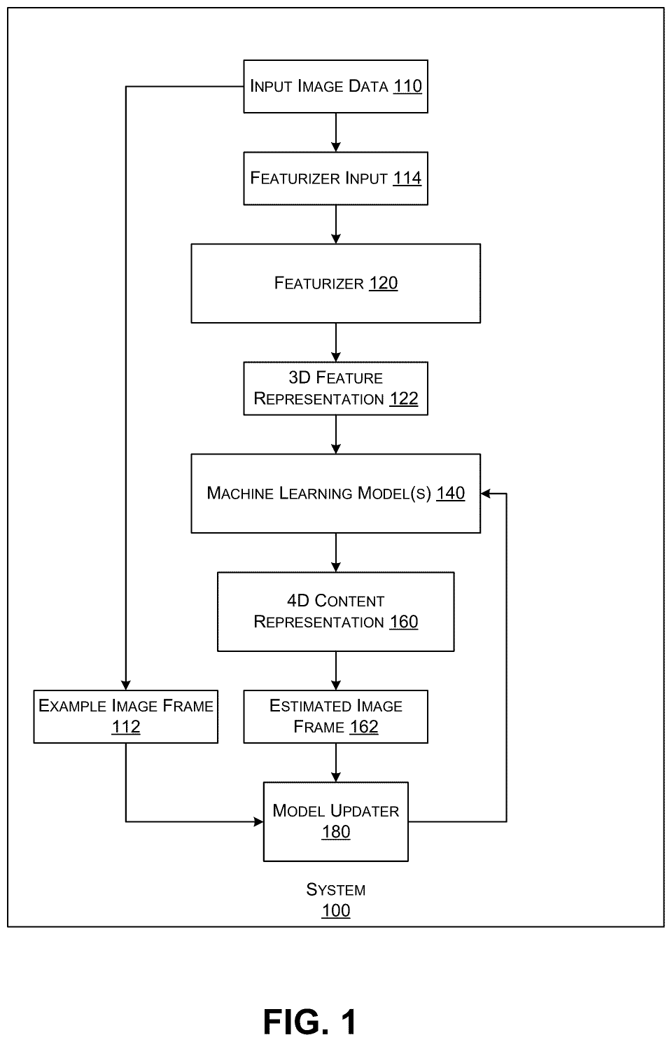

FIG. 1 is a block diagram of an example system 100 for reconstruction and synthesis of dynamic scenes from video data using neural networks, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine learning model), operation, routine, logic, or instructions to perform functions such as configuring machine learning models 140 as described herein, such as to configure machine learning models to operate as transformer-based models, attention-based models, or various combinations thereof, including for reconstruction and synthesis of dynamic scenes from video data.

In some implementations, the system 100 performs operations in a 3D frame of reference. The 3D frame of reference can be a frame of reference of a sensor (e.g., sensor used to detect image data 110) or a platform to which the sensor is coupled, such as a rig or vehicle. For example, the 3D frame of reference can be an X-Y-Z coordinate frame of reference in which (positive) X corresponds to a forward direction, (positive) Y corresponds to a left direction, and (positive) Z corresponds to a Z direction.

The system 100 can perform operations on input image data 110, which can include various forms of image-based sensor data. The input image data 110 can include, for example and without limitation, camera data, ultrasound sensor data, LIDAR data, RADAR data, or various combinations thereof. The image data 110 can be retrieved from any of various databases or sensors (e.g., LIDAR sensors, RADAR sensors, ultrasound sensors, one or more cameras such as one or more monocular cameras, image capture devices, etc.). For example, the image data 110 can be retrieved from sensors, or can be retrieved from one or more databases in which image data are stored subsequent to detection. The image data 110 can be retrieved from sensors coupled with vehicles, such as autonomous vehicles.

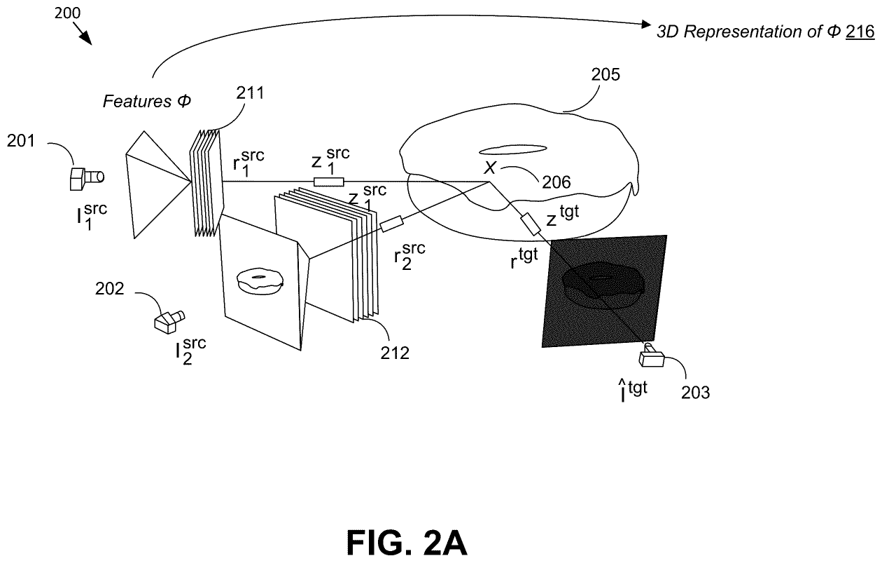

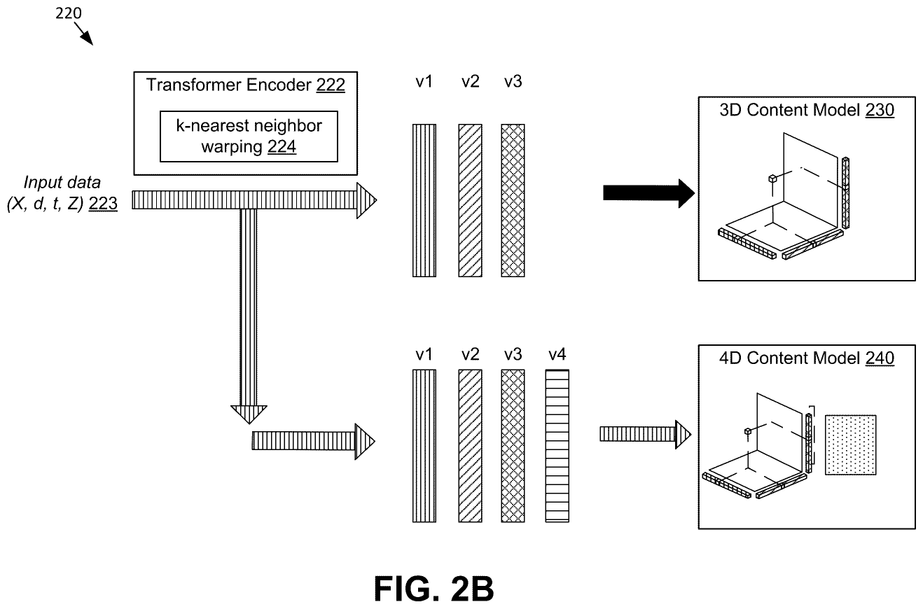

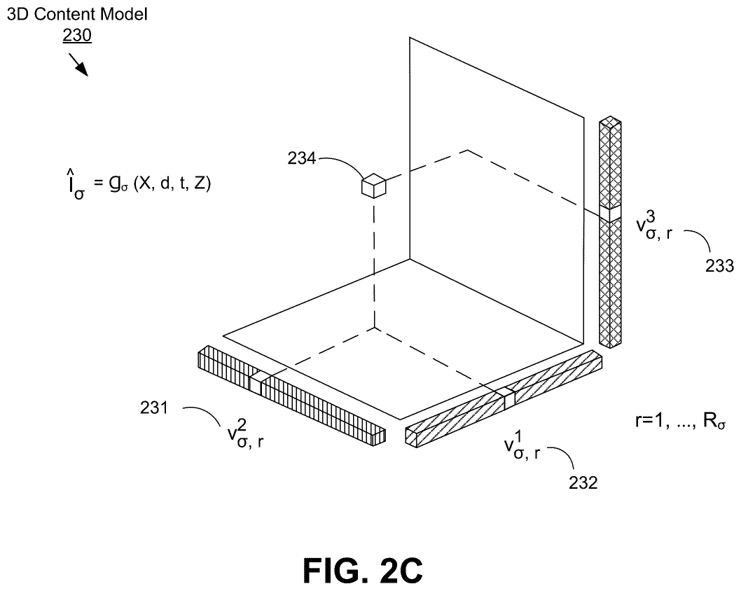

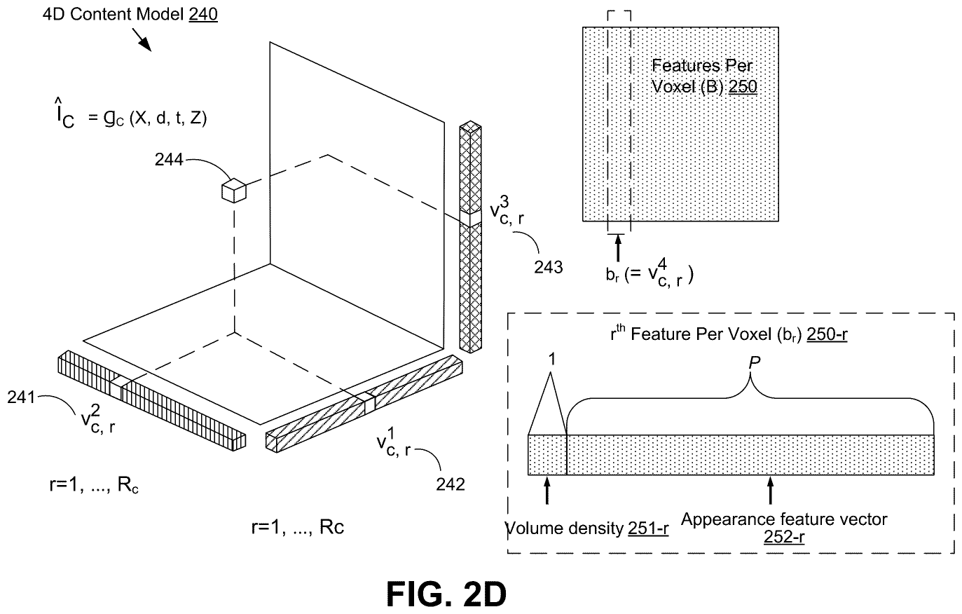

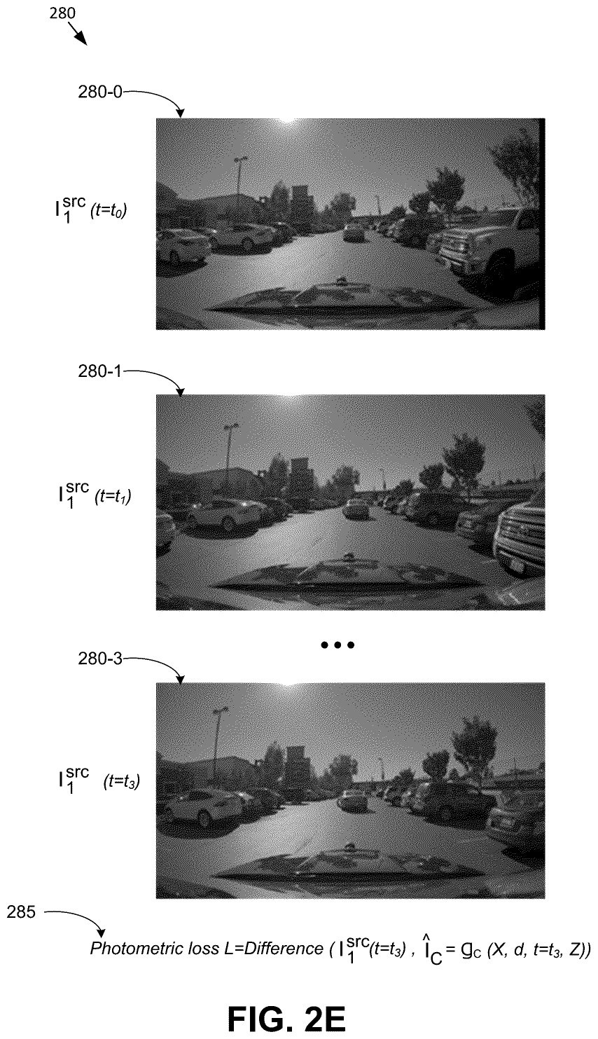

FIG. 2A is a schematic diagram of an example system environment 200 for reconstruction and synthesis of dynamic scenes from video data, in accordance with some embodiments of the present disclosure. The system environment 200 may include one or more sensors (e.g., monocular cameras 201, 202) and an object 205. Each monocular camera 201, 202 may correspond to (1) an origin or an optical center of perspective r₁^{src}, r₂^{src} of the cameras and (2) a feature vector z₁^{src}, z₂^{src} that includes the representation from the origin/center r₁^{src}, r₂^{src} of a point X (206) on the object 205. Each monocular camera having intrinsic properties (represented by a matrix K) and extrinsic properties (represented by a matrix M) can obtain, collect, compute, calculate 2D images I₁^{src}, I₂^{src} (represented by a 2D image coordinate [u v 1]⁻¹) corresponding to a 3D world point (represented by a 3D world coordinate [U V W 1]⁻¹) using the following equation:

$$S [ \begin{matrix}u \\ v \\ 1\end{matrix} ] = K M [ \begin{matrix}U \\ V \\ W \\ 1\end{matrix} ] , \qquad ( Equation 1 )$$

$$S [ \begin{matrix}u \\ v \\ 1\end{matrix} ] = [ \begin{matrix}f & 0 & {p}_{x} \\ 0 & f & {p}_{y} \\ 0 & 0 & 1\end{matrix} ] [ \begin{matrix}{rt}_{1} & {rt}_{2} & {rt}_{3} & \vert & {tr}_{1} \\ {rt}_{4} & {rt}_{5} & {rt}_{6} & \vert & {tr}_{2} \\ {rt}_{7} & {rt}_{8} & {rt}_{9} & \vert & {tr}_{3}\end{matrix} ] [ \begin{matrix}U \\ V \\ W \\ 1\end{matrix} ]$$

where s is a scaling factor, f is a focal length in pixel, [pₓ, p_{y}] is an optical center in pixels, rt₁, rt₂ . . . , and rt₉ indicate camera rotation, tr₁, tr₂ and tr₃ indicate camera translation. Using Equation 1, each molecular camera 201, 202 can obtain, collect, compute, calculate respective 2D images I₁^{src}, I₂^{src} which are sequences of 2D image frames 211, 212 (of the object 205 or the point X 206). Using the 2D images I₁^{src}, I₂^{src} and additional information (e.g., pose information such as origins r₁^{src}, r₂^{src} and directions z₁^{src}, z₂^{src} of cameras), the system 100 can reconstruct or synthesize one or more target 2D images I^{tgt} from a target camera 203 having an origin r^{tgt} and a direction z^{tgt} to a particular point of an object (e.g., the point X 206 of the object 205).

Referring further to FIG. 1, the image data 110 may include one or more videos that can be represented as a sequence of images, and additional data associated with each image. In some implementations, the additional data associated with each image may include a time (e.g., time step, time point) of capturing the image, and a camera pose indicating a pose (e.g., position and orientation relative to a given coordination system) of the camera that captured the video. In some implementations, the additional data associated with each image may include data values including a point X in a scene/object captured in the image (e.g., a point in the scene/object positioned in a center of the image), a distance or depth d from the point X to the camera, and/or a time t.

The image data 110 can include images (e.g., sensor images) of multiple views and/or multiple time points (e.g., 2D image frames 211, 212 in FIG. 2A). For example, the image data 110 can include a plurality of images from multiple poses (e.g., different origins/centers r₁^{src}, r₂^{src} and/or different directions z₁^{src}, z₂^{src} in FIG. 2), such as from multiple sensors coupled at different locations to a vehicle. The poses of the images can correspond to position and orientation of a sensor (e.g., monocular camera) relative to a given coordination system. The poses of the images can correspond to an origin and direction (e.g., perspective) of the images (e.g., origins r₁^{src}, r₂^{src} and directions z₁^{src}, z₂^{src} in FIG. 2). This can include, for example and without limitation, front, left, and right poses of sensors on a vehicle. The images from multiple poses can be detected at the same or different time points. The image data 110 can include images detected at multiple points in time for each of one or more respective sensors and/or poses. For example, the image data 110 can include one or more of a first sensor image of (e.g., detected from) a first pose at a first time point, a second sensor image of a second pose at the first time point, a third sensor image of a third pose at the first time point, a fourth sensor image of the first pose at a second time point, a fifth sensor image of the second pose at the second time point, a sixth sensor image of the third pose at the second time point, etc. In some implementations, the image data 110 includes camera image frames from a front camera (e.g., 120 degree field of view), side left, side right, rear left, and rear right (e.g., 200 degree field of view) cameras, such as to include 6 frames at each time step (e.g., at time T, time T+1, etc.).

The image data 110 can have information regarding the sensor(s) that detected the images assigned to the image data 108. For example, the image data 110 can include information such as a center of the sensors (e.g., camera origins/centers r₁^{src}, r₂^{src}) or a direction of the sensors (e.g., camera ray vectors z₁^{src}, z₂^{src}) that detected the images assigned to the images. As described further herein, this can enable the system 100 to configure a featurizer 120 and/or the models 140 to learn position information regarding features (e.g., as opposed to directly relying on position information in the images).

The system 100 can include at least one featurizer 120 (e.g., featurizer processor). The featurizer 120 can include one or more instructions, rules, heuristics, models, policies, functions, algorithms, etc., to perform operations including identifying features (e.g., representations of objects or other structures in the environment; features Φ in FIG. 2A) from image data 114 which is a subset of the input image data 110 (e.g., image frames), such as a subset of image frames from one or more videos to be used as training data. The featurizer 120 can determine feature data from the image data 114 (e.g., the subset of the image frames). A remaining one or more image frames of the training data as example image data 112 can be used for supervision as described further herein. For example, the example image data 112 can be from a time step t₃, having a target pose, while the image data 114 can be from time steps t₀, t₁, t₂. As such, the featurizer 120 can determine features Φ from the images at time steps t₀, t₁, t₂. The featurizer can determine features Φ relating to various groups of pixels. The featurizer 120 can process the input image data 114 to generate a modified representation of the image data 114, such as a 3D representation or a 3D feature cloud of the input image data 114 (e.g., 3D representation of feature Φ 216 in FIG. 2A).

The featurizer 120 can include a neural network, such as at least one of a convolutional neural network (CNN), encoder, latent diffusion model (LDM), vector quantized variational auto-encoder (VQVAE), flow model, RAFT flow model, pretrained depth model. The neural network can be pre-trained using existing general purpose datasets or specific scenes related to the task, such as scenes from autonomous vehicle camera captures. In some implementations, the neural network can be learned as part of training the machine learning models 140. The featurizer 120 can be trained (or pre-trained) using image data (e.g., images analogous to image data 114) labeled with indications of features to detect, enabling the featurizer 120 to determine a representation of image data indicating features (e.g., 3D feature representation or 3D feature cloud). In some implementations, the featurizer 120 determines the representation of image data indicating features to have a different number of dimensions (e.g., more dimensions) than the image data 114. For example, the featurizer 120 can determine a 3D representation of image data (e.g., 3D feature cloud) while the image data 114 has two dimensions (e.g., 2D video data from a monocular camera).

The system 100 can train, update, or configure one or more models 140. The models 104 can include machine learning models or other models that can generate target outputs based on various types of inputs. The models 104 may include one or more neural networks. The neural network(s) can include an input layer, an output layer, and/or one or more intermediate layers, such as hidden layers, which can each have respective nodes. The system 100 can train/update the neural network by modifying or updating one or more parameters, such as weights and/or biases, of various nodes of the neural network responsive to evaluating estimated outputs of the neural network.

The models 140 can be or include various neural network models, including models that are effective/implemented for operating on or generating data including but not limited to image data, video data, text data, speech data, audio data, or various combinations thereof. The models 104 can include one or more transformers, detection transformers (DETRs), deep neural networks (DNNs), convolutional neural networks (CNNs), recurrent neural networks (RNNs), long short-term memory (LSTM) models, other network types, or various combinations thereof. The models 140 can include generative models, such as generative adversarial networks (GANs), Markov decision processes, variational autoencoders (VAEs), Bayesian networks, transformer models, perceiver models, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof. The models 140 can include neural networks models used by the featurizer 120 and/or a model updater 180. For example, the models 140 can include at least one of pre-trained featurizer, encoder, LDM, VQVAE, flow model, RAFT flow model, pretrained depth model, for use by the featurizer 120 or other modules (e.g., model updater 180). The models 140 can include a non-linear transformation model, for example, a warped k-nearest neighbor model (or a warped k-nearest neighbor algorithm).

The models 140 can include a transformer model (e.g., transformer encoder and/or transformer decoder). Using features (e.g., features Φ or 3D feature cloud) determined by the featurizer 120, the transformer model can be fit to the determined features. The transformer model can determine (e.g., predict) parameters of a 4D content model or 4D content representation (e.g., 4D rendering model [symbol] _{C}) corresponding to the scenes from one or more videos. In some implementations, the transformer can determine (e.g., predict) parameters of a 3D content model or a 3D content representation (e.g., 3D rendering model [symbol] _{σ}) corresponding to the scenes from the one or more videos.

FIG. 2B is a schematic diagram of an example neural network 220 that can be used in the example system of FIG. 1, in accordance with some embodiments of the present disclosure. A transformer 222 (e.g., transformer encoder) may generate, based on the 3D representation of the feature Φ (e.g., 3D representation 216), at least one of a 3D content model 230 with respect to 3 dimensions v1, v2 and v3, or a 4D content model 240 with respect to 4 dimensions v1, v2, v3 and v4. In some implementations, the transformer 222 can perform a k-nearest neighbor warping or a warped k-nearest neighbor algorithm 224 (where k is an integer) to obtain a warped (transformed) feature space, and condition embedding of the transformer 222 on the warped feature space. For example, the transformer 222 can determine, based on the warped feature space, parameters of a 4D content model (or a 3D content model) corresponding to the scenes from one or more videos. In some implementations, the number k is a predetermined, fixed number. In some implementations, the transformer 222 may receive the number k as input from a user. The transformer 222 may receive additional information such as information relating to a movement of cameras (e.g., a velocity, an acceleration, and/or a direction change of a vehicle equipped with one or more monocular cameras). The 3D content model 230 and the 4D content model 240 will be described in more detail in the following sections.

The transformer 222 may receive input data 223 (e.g., training data) including at least a coordinate of a point X, a feature (vector) Z, a distance or depth d from an origin of a camera to the point X in the direction Z, and a time t, for training the 3D/4D content model. For example, the transformer 222 (or the 4D content model 240 or the model updater 180) may estimate an image frame using the input data (X, d, t, Z), compare the estimated image frame with an example image frame 112, and update the 4D content model 240 based on a result of the comparing. The details of training/updating the transformer will be described in more detail in the following sections.

FIG. 2C is a schematic diagram of an example 3D content model 230 that can be generated by the example system of FIG. 1 for reconstruction and synthesis of dynamic scenes, in accordance with some embodiments of the present disclosure. The 3D content model 230 may be or include one or more 3D tensors. The 3D content model 230 may include a 3D rendering model or 3D rendering network [symbol] _{σ}. In some implementations, the 3D rendering network [symbol] _{σ} may include one or more neural networks. The 3D content model 230 may estimate an image frame Î_{σ} using the following equation:

$${\hat{I}}_{σ} = {g}_{σ} ( X , d , t , Z ) , \qquad ( Equation 2 )$$

where X is a coordinate of a point (of an object or scene), Z is a direction vector Z, d is a distance or depth from an origin of a camera to the point X in the direction Z, and t is a time. The estimated image frame Î may represent a reconstructed/synthesized image frame of an object/scene including the point X, which would be created/taken/shot by a camera whose origin is away from the point X in the direction Z. The 3D rendering model [symbol] _{σ} may include a plurality of 3D rendering models [symbol] _{σ,r} corresponding to a plurality of camera poses r=1, . . . , R_{σ}(R_{σ} is an integer greater than 1). Each of the poses can be defined by an origin and a direction, for example. Each of the plurality of 3D rendering [symbol] _{σ,r} may be defined with respect to three dimensions, v_{σ,r}¹, (231), v_{σ,r}², (232) and v_{σ,r}³(233), which can form a 3D coordinate of a voxel 234.

Using the input values (X, d, t, Z), the 3D rendering model [symbol] _{σ} can determine/select a pose r (among 1, . . . , R_{σ}), and then predict/estimate/calculate a plurality of voxels (including the voxel 234 corresponding to the point X) as the image frame Î_{σ}, using a 3D rendering model [symbol] _{σ,r} . In determining/selecting the pose r, the 3D rendering model [symbol] _{σ} may use information relating to a movement of cameras (e.g., a velocity, an acceleration, and/or a direction change of a vehicle equipped with one or more monocular cameras) in addition to the input values (X, d, t, Z). In some implementations, the voxel 234 may represent one of two colors (black or white, for example). For example, the voxel 234 may be a one-bit representing whether the voxel has a volume (e.g., binary value 1) or not (e.g., binary value 0).

FIG. 2D is a schematic diagram of an example 4D content model 240 that can be generated by the example system of FIG. 1 for reconstruction and synthesis of dynamic scenes, in accordance with some embodiments of the present disclosure. The 4D content model 240 may be or include one or more 4D tensors. The 4D content model 240 may include a 4D rendering model or 4D rendering network [symbol] _{C}. In some implementations, the 4D rendering network [symbol] _{C} may include one or more neural networks. The 4D content model 240 may estimate an image frame Î_{C} using the following equation:

$${\hat{I}}_{C} = {g}_{C} ( X , d , t , Z ) , \qquad ( Equation 3 )$$

where X is a coordinate of a point (of an object), Z is a feature vector Z, d is a distance or depth from an origin of a camera to the point X, and t is a point in time. The estimated image frame Î may represent a reconstructed/synthesized image frame of an object/scene with the point X, which would be created/taken/shot by a camera whose origin is away from the point X in the direction Z. The 4D rendering model [symbol] _{C} may include a plurality of 4D rendering models [symbol] _{C,r} corresponding to a plurality of camera poses r=1, . . . , R_{C} (R_{C} is an integer greater than 1). Each of the poses can be defined by an origin and a direction, for example. Each of the plurality of 4D rendering [symbol] _{C,r} may be defined with respect to three dimensions, v_{C,r}¹(241), v_{C,r}²(242), v_{C,r}³(243) and v_{C,r}⁴(244). The three dimensions, v_{C,r}¹(241), v_{C,r}²(242) and v_{C,r}³(243) can form a 3D coordinate of a voxel 244. The fourth dimension v_{C,r}⁴, 244 (also denoted by bᵣ) can represent a volume density and an appearance feature of the voxel 244.

Using the input values (X, d, t, Z), the 4D rendering model [symbol] _{C} can determine/select a pose r (among 1, . . . , R_{C}), and then predict/estimate/calculate a plurality of voxels (including the voxel 244 corresponding to the point X) as the image frame ÎC, using a 4D rendering model [symbol] _{C,r}. In determining/selecting the pose r, the 4D rendering model [symbol] _{C} may use information relating to a movement of cameras (e.g., a velocity, an acceleration, and/or a direction change of a vehicle equipped with one or more monocular cameras) in addition to the input values (X, d, t, Z). In some implementations, a voxel in the plurality of 4D rendering [symbol] _{C,r} (r=1, . . . , R_{C}) may be associated with a plurality of features 250 (denoted by features per voxel B). The plurality of features 250 may include an R_{C} number of features bᵣ corresponding to the camera poses (r=1, . . . , R_{C}). In some implementations, an r^{th} feature per voxel bᵣ (250-r) may include a volume density 251-r and an appearance feature vector 252-r. For example, the volume density 251-r may be a one bit representing whether the voxel has a volume (e.g., binary value 1) or not (e.g., binary value 0). The appearance feature vector 252-r may be a P number of bits (where P is a positive integer) representing an appearance of the voxel (e.g., color, opacity, etc.).

Referring further to FIG. 1, the system 100 can include at least one model updater 180. The updater 180 can include one or more instructions, rules, heuristics, models, policies, functions, algorithms, etc., to perform operations including updating the one or more machine learning models (e.g., transformer). The updater 180 can update (e.g., train) the transformer model (e.g., transformer 222) by (1) retrieving (or calculating, computing, obtaining) an estimated image from a content model (e.g., a 3D content model or a 4D content model) for a target pose and a target time step, (2) comparing the estimated image with an example image frame having the target pose and the target time step, and (3) updating the transformer model and/or the content model based on a result of the comparing.

In retrieving the estimated image, the updater 180 may receive a target pose and a target time step, which are defined by data values (a coordinate of a point X, a direction Z, a distance d from the point X to a camera in the direction Z, a time step t), and retrieve (or calculate, compute, obtain) the estimated image (e.g., estimate image Î_{C}) from a 4D rendering model [symbol] _{C} using Equation 3. In some implementations, the updater 180 may receive a target pose and a target time step, which are defined by data values (X, Z, d, t), and retrieve (or calculate, compute, obtain) the estimated image (e.g., estimate image Î.) from a 3D rendering model [symbol] _{σ} using Equation 2. In some implementations, the updater 180 or the transformer 222 can perform volume rendering on the 4D content model 240 with respect to the target pose and the target time step which are defined by data values (X, Z, d, t). In some implementations, the updater 180 or the transformer 222 can perform volume rendering on the 3D content model 230 with respect to the target pose and the target time step which are defined by data values (X, Z, d, t).

In comparing the estimated image with the example image frame having the target pose and the target time step, the updater 180 can compare the estimated image with the example image frame (e.g., example image frame 112), such as with a loss function (e.g., photometric and regularization loss functions), to update the transformer model until such comparisons satisfy a convergence condition. For example, the updater 180 may calculate, as a photometric loss, a difference between the estimated image and the example image frame, and update (e.g., adjust, modify, recondition, improve) parameters of the transformer model and/or the content model (e.g., by backpropagation) to minimize the photometric loss.

FIG. 2E is a schematic diagram 280 of example image frames 280-0, 280-1, 280-3 that can be used by the example system of FIG. 1 for reconstruction and synthesis of dynamic scenes, in accordance with some embodiments of the present disclosure. The example image frames 280-0, 280-1, 280-3 may correspond to image frames I₁^{src} captured by a (monocular) camera 201 from time steps t₀, t₁, t₃, respectively (e.g., t₀<t₁<t₃).

Referring further to FIG. 1, the featurizer 120 can determine feature data from the image data 114 (e.g., the image frames 280-0, 280-1 from time steps t₀, t₁) of the training data (e.g., input image data 110). A remaining one or more image frames of the training data as example image data 112 (e.g., the image frame 280-3 from time step t₃) can be used by the updater 180 to update a transformer model (e.g., transformer 222) or a content model (e.g., 4D content model 240). Using features (e.g., features Φ or 3D feature cloud) determined by the featurizer 120, the transformer model can determine (e.g., predict) parameters of the 4D content model 240 corresponding to the scenes from one or more videos.

To train the transformer model and/or the 4D content model 240, the updater 180 may receive a target pose and a target time step, which are defined by data values (a coordinate of a point X, a distance d from the point X to a camera, features Z coming from the featurizer Φ, a time step t=t₃,) corresponding to the image frame 280-3 from time step t₃. Using the data values (X, d, t=t₃, Z), the updater 180 may retrieve (or calculate, compute, obtain) the estimated image (e.g., estimate image Î_{C}) from the 4D rendering model [symbol] _{C} using Equation 3. The updater 180 may then compare the estimated image Î_{C} with the example image frame 280-3, such as with a loss function (e.g., photometric and regularization loss functions), to update the transformer model until such comparisons satisfy a convergence condition. For example, the updater 180 may calculate, as a photometric loss, a difference between the estimated image Î_{C} and the example image frame 280-3, and update (e.g., adjust, modify, recondition, improve) parameters of the transformer model 222 and/or the 4D content model 240 to minimize the photometric loss.

With reference to the systems of FIG. 1 and FIGS. 2A-2E, at least one aspect relates to a system (e.g., system 100) including one or more processors to execute operations. The operations may include receiving an input (e.g., a 3D feature representation or 3D cloud of features 122, a 3D representation of feature Φ 216) indicating one or more features of content (e.g., one or more image frames from one or more video data), the content representing at least one of an object or a scene. The operations may include initializing a content model (e.g., 4D content model 240) that is generated by a neural network (e.g., transformer 222) using a transformation (e.g., a warped k-nearest neighbor algorithm), according to the input, to represent one or more images in three spatial dimensions (e.g., v_{C,r}¹(241), v_{C,r}²(242), v_{C,r}³, (243) and a fourth dimension (e.g., v_{C,r}⁴, (244)). The operations may include updating the content model by rendering one or more image frames (e.g., estimate image Î_{C}) from the content model (e.g., a 4D rendering model [symbol] _{C}), determining a metric of the one or more frames (e.g., a photometric loss, a difference between the estimated image Î_{C} and the example image frame 280-3), and modifying the content model according to the metric, until a convergence condition is satisfied.

In some implementations, the input (e.g., 3D feature representation or 3D cloud of features 122, 3D representation of feature Φ216) may be generated using a plurality of first image frames (e.g., featurizer input image data 114 such as image frames 280-0, 280-1 from time step to, t₁) from video data of one or more scenes. In updating the content model, the one or more processors may identify a second image frame of the video data of the one or more scenes (e.g., example image data 112 such as the image frame 280-3 from time step t₃), the second image frame having a pose and a time. The one or more processors may determine, from the content model (e.g., a 4D rendering model [symbol] _{C}), an estimated image (e.g., estimate image Î_{C}) having the pose and the time. For example, the pose and the time can be defined by data values (a coordinate of a point X, a distance d from the point X to a camera, a time step t=t₃,) corresponding to the image frame 280-3 from time step t₃. The one or more processors may update the neural network (e.g., transformer 222 or 4D rendering model [symbol] _{C}) the according to a comparison of the estimated image (e.g., estimate image Î_{C}) with the second image (e.g., the image frame 280-3) based on the metric. The plurality of first image frames (e.g., image frames 280-0, 280-1) may have a plurality of first time steps (e.g., time steps t₀, t₁). The second image frame (e.g., image frame 280-3) may have a second time step (e.g., time step t₃) subsequent to the plurality of first time steps (e.g., time steps t₀, t₁).

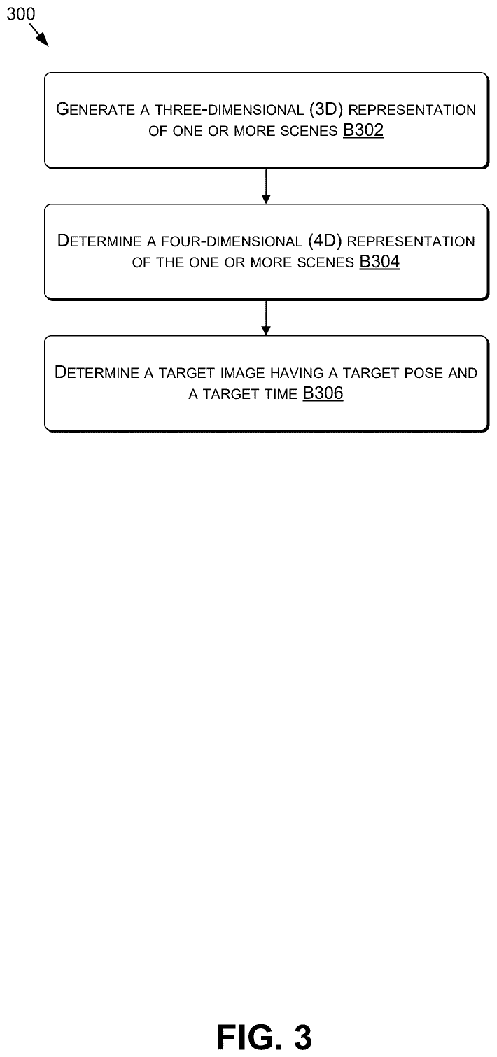

FIG. 3 is a flow diagram showing a method 300 for reconstruction and synthesis of dynamic scenes from video data using neural networks, in accordance with some embodiments of the present disclosure. Various operations of the method 300 can be implemented by the same or different devices or entities at various points in time. For example, one or more first devices may implement operations relating to configuring (e.g., updating or training) neural networks (e.g., transformer model or 3D/4D rendering models) and other machine learning models, and one or more second devices may implement operations relating to determining a target image having a target pose and a target time. The one or more second devices may maintain the neural networks, or may access the neural networks using, for example and without limitation, APIs provided by the one or more first devices.

Each block of method 300, described herein, includes a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the systems of FIG. 1 and FIGS. 2A-2E. However, this method 300 may additionally or alternatively be executed by any one system, or any combination of systems, including, but not limited to, those described herein.

The method 300, at block B302, includes generating, using one or more processors by a featurizer (e.g., featurizer 120) using a plurality of first image frames from video data of one or more scenes (e.g., featurizer input image data 114 such as image frames 280-0, 280-1 from time step t₀, t₁), a three-dimensional (3D) representation of the one or more scenes (e.g., 3D feature representation or 3D cloud of features 122, 3D representation of feature Φ216). In some implementations, the featurizer may include at least one of a latent diffusion model, a flow model, or a depth model. In some implementations, the 3D representation may include a 3D feature cloud. In some implementations, the featurizer may be a pre-trained model configured using vehicle camera data (e.g., data similar to input image data 114 such as image frames 280-0, 280-1).

The method 300, at block B304, includes determining, using the one or more processors by a neural network (e.g., transformer 222) implemented according to the 3D representation of the one or more scenes (e.g., 3D feature representation or 3D cloud of features 122, 3D representation of feature Φ216), a four-dimensional (4D) representation of the one or more scenes (e.g., 4D content model 240, or 4D rendering model [symbol] _{C}). In some implementations, the 4D representation may include at least one of a 4D tensor or a 4D neural radiance field (NeRF).

The method 300, at block B306, includes determining, using the one or more processors from the 4D representation (e.g., 4D content model 240, or 4D rendering model [symbol] _{C}), a target image (e.g., target 2D images I^{tgt}) having a target pose (e.g., an origin r^{tgt} and a direction z^{tgt}) and a target time. In some implementations, the method may include applying a volume rendering to the 4D representation (e.g., 4D rendering model [symbol] _{C}), according to the target pose and the target time to retrieve the target image (e.g., target 2D images I^{tgt}). For example, the target image can be retrieved from the 4D rendering model [symbol] _{C} 4D according to a target pose and a target time defined by data values including a point X in a scene/object captured in the image (e.g., a point in the scene/object positioned in a center of the image), a direction (or direction vector) Z from the point X to the camera that captured the video, a distance or depth d from the point X to the camera, and/or a time t.

In some implementations, the method may include identifying a second image frame of the video data of the one or more scenes, the second image frame (e.g., image frame 280-3 from time step t₃) having a second pose and a second time. The method may include determining, from the 4D representation (e.g., 4D content model 240, or 4D rendering model [symbol] _{C}), an estimated image (e.g., estimated image Î_{C}) having the second pose and the second time (e.g., using data values (X, d, t, Z) corresponding to the second pose and the second time). The method may include updating the neural network (e.g., transformer 222 or 4D rendering model [symbol] _{C}) according to a comparison of the estimated image (e.g., estimated image Î_{C}) with the second image frame (e.g., image frame 280-3). In some implementations, the method may include performing the comparison of the estimated image and the second image frame according to a photometric loss function (e.g., a photometric loss, a difference between the estimated image Î_{C} and the example image frame 280-3). In some implementations, the plurality of first image frames (e.g., image frames 280-0, 280-1) may have a plurality of first time steps (e.g., time steps t₀, t₁), and the second image frame (e.g., image frame 280-3) may have a second time step (e.g., time step t₃) subsequent to the plurality of first time steps (e.g., time steps t₀, t₁).

### Example Content Streaming System

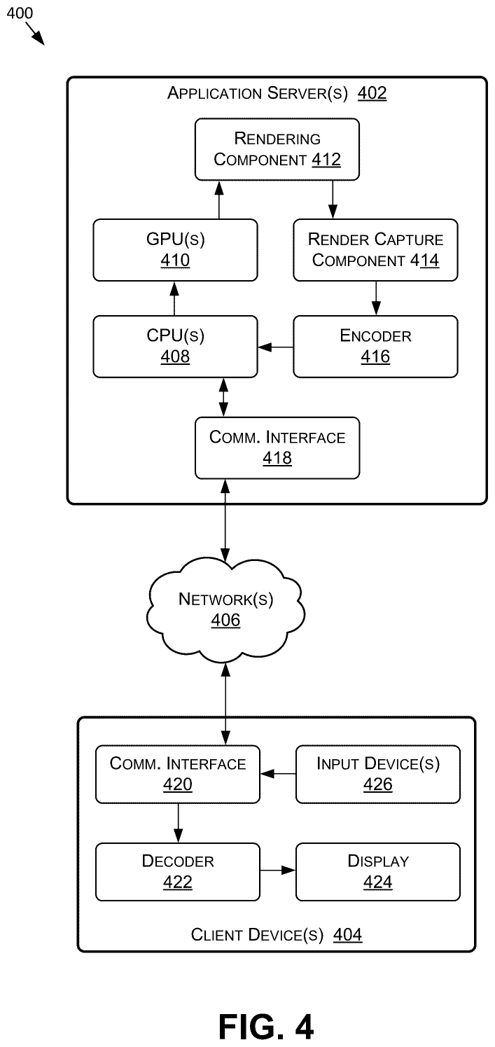

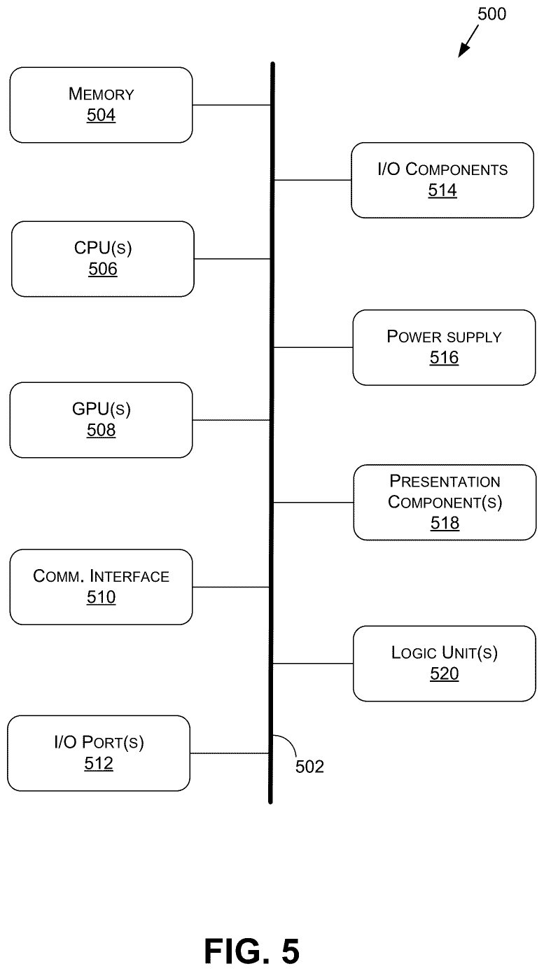

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented to perform diffusion model training and runtime operations. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations including display or simulation operations.

In the system 400, for an application session, the client device(s) 404 may only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based on receiving the display data from the application server(s) 402. The client device 404 may receive an input to one of the input device(s) and generate input data in response, such as to provide modification inputs of a driving signal for use by modifier 112. The client device 404 may transmit the input data to the application server(s) 402 via the communication interface 420 and over the network(s) 406 (e.g., the Internet), and the application server(s) 402 may receive the input data via the communication interface 418. The CPU(s) 408 may receive the input data, process the input data, and transmit data to the GPU(s) 410 that causes the GPU(s) 410 to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424, such as to display a top-down/BEV map of a scene or an environment.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may be arranged in various topologies, including but not limited to bus, star, ring, mesh, tree, or hybrid topologies. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508. In some embodiments, a plurality of computing devices 500 or components thereof, which may be similar or different to one another in various respects, can be communicatively coupled to transmit and receive data for performing various operations described herein, such as to facilitate latency reduction.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user, such as to generate a driving signal for use by modifier 112, or a reference image (e.g., images 104). In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

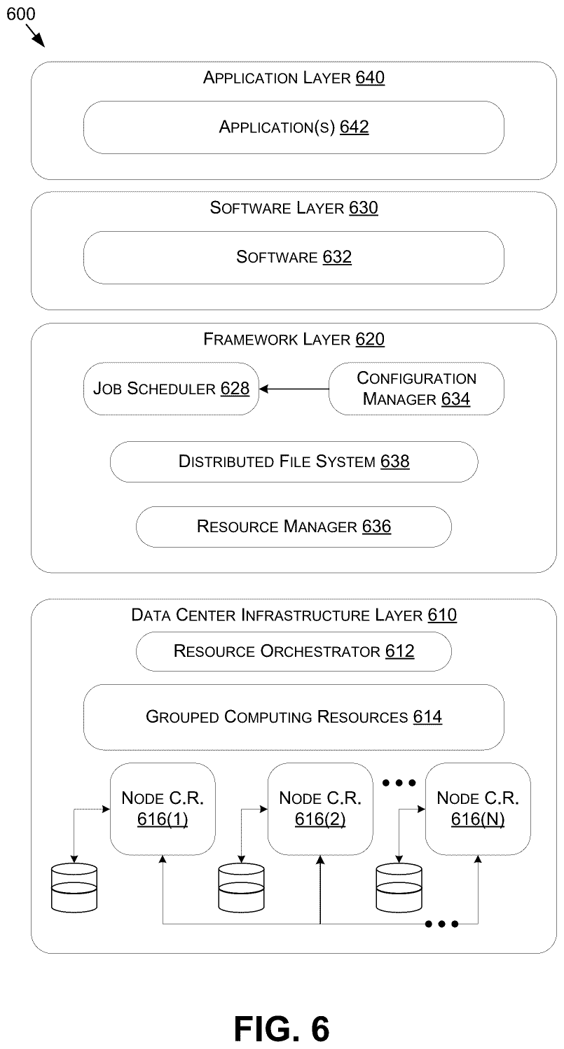

FIG. 6 illustrates an example data center 600 that may be used in at least one embodiments of the present disclosure, such as to implement the systems 100, 200 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 104.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train models 104, 204 and/or neural networks 106, 206, etc.) or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (Asrcs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one more circuits to:
determine, using a neural network and based on a three-dimensional (3D) representation of one or more scenes, a four-dimensional (4D) representation of the one or more scenes, the 3D representation generated by a featurizer using a plurality of first image frames from video data of the one or more scenes; and
determine, from the 4D representation, a target image having a target pose and a target time.

2. The processor of claim 1, wherein the featurizer comprises at least one of a latent diffusion model, a flow model, or a depth model.

3. The processor of claim 1, wherein the featurizer is a pre-trained model configured using vehicle camera data.

4. The processor of claim 1, wherein the 3D representation comprises a 3D feature cloud, and the 4D representation comprises at least one of a 4D tensor or a 4D neural radiance field (NeRF).

5. The processor of claim 1, wherein the one or more circuits are to apply a volume rendering to the 4D representation, according to the target pose and the target time, to retrieve the target image.

6. The processor of claim 1, wherein the neural network comprises a transformer, and the one or more circuits are to update the transformer by:
identifying a second image frame of the video data of the one or more scenes, the second image frame having a second pose and a second time;
determining, from the 4D representation, an estimated image having the second pose and the second time; and
updating the transformer according to a comparison of the estimated image with the second image frame.

7. The processor of claim 6, wherein the one or more circuits are to perform the comparison of the estimated image and the second image frame according to a photometric loss function.

8. The processor of claim 6, wherein the plurality of first image frames have a plurality of first time steps, and the second image frame has a second time step subsequent to the plurality of first time steps.

9. The processor of claim 1, wherein the processor is comprised in at least one of:
a system for generating synthetic data;
a system for performing simulation operations;
a system for performing conversational AI operations;
a system for performing collaborative content creation for 3D assets;
a system comprising one or more large language models (LLMs);
a system for performing digital twin operations;
a system for performing light transport simulation;
a system for performing deep learning operations;
a system implemented using an edge device;
a system implemented using a robot;
a control system for an autonomous or semi-autonomous machine;
a perception system for an autonomous or semi-autonomous machine;
a system incorporating one or more virtual machines (VMs);
a system implemented at least partially in a data center; or
a system implemented at least partially using cloud computing resources.

10. A system comprising:
one or more processors execute operations comprising:
receiving an input indicating one or more features of content, the content representing at least one of an object or a scene;
initializing a content model that is generated by a neural network using a transformation according to the input, to represent one or more images in three spatial dimensions and a fourth dimension; and
updating the content model by rendering one or more image frames from the content model, determining a metric of the one or more frames, and modifying the content model according to the metric, until a convergence condition is satisfied.

11. The system of claim 10, wherein
the input is generated using a plurality of first image frames from video data of one or more scenes, and
updating the content model comprises:
identifying a second image frame of the video data of the one or more scenes, the second image frame having a second pose and a second time;
determining, from the content model, an estimated image having the second pose and the second time; and
updating the neural network according to a comparison of the estimated image with the second image based on the metric.

12. The system of claim 11, wherein the plurality of first image frames have a plurality of first time steps, and the second image frame has a second time step subsequent to the plurality of first time steps.

13. The processor of claim 10, wherein the processor is comprised in at least one of:
a system for generating synthetic data;
a system for performing simulation operations;
a system for performing conversational AI operations;
a system for performing collaborative content creation for 3D assets;
a system comprising one or more large language models (LLMs);
a system for performing digital twin operations;
a system for performing light transport simulation;
a system for performing deep learning operations;
a system implemented using an edge device;
a system implemented using a robot;
a control system for an autonomous or semi-autonomous machine;
a perception system for an autonomous or semi-autonomous machine;
a system incorporating one or more virtual machines (VMs);
a system implemented at least partially in a data center; or
a system implemented at least partially using cloud computing resources.

14. A method comprising:
generating, using one or more processors by a featurizer using a plurality of first image frames from video data of one or more scenes, a three-dimensional (3D) representation of the one or more scenes;
determining, by the one or more processors using a neural network and based on the 3D representation of the one or more scenes, a four-dimensional (4D) representation of the one or more scenes; and
determining, using the one or more processors from the 4D representation, a target image having a target pose and target time.

15. The method of claim 14, wherein the featurizer comprises at least one of a latent diffusion model, a flow model, or a depth model.

16. The method of claim 14, wherein the 3D representation comprises a 3D feature cloud, and the 4D representation comprises at least one of a 4D tensor or a 4D neural radiance field (NeRF).

17. The method of claim 14, further comprising:
applying a volume rendering to the 4D representation, according to the target pose and the target time, to retrieve the target image.

18. The method of claim 14, further comprising:
identifying a second image frame of the video data of the one or more scenes, the second image frame having a second pose and a second time;
determining, from the 4D representation, an estimated image having the second pose and the second time; and
updating the neural network according to a comparison of the estimated image with the second image frame.

19. The method of claim 18, further comprising:
performing the comparison of the estimated image and the second image frame according to a photometric loss function.

20. The method of claim 18, wherein the plurality of first image frames have a plurality of first time steps, and the second image frame has a second time step subsequent to the plurality of first time steps.
